(19) United States
(12) Patent Application Publication
(10) Pub. No.: US 2021/0067666 A1
(43) Pub. Date: Mar. 4, 2021

(54) LENS MODULE AND ELECTRONIC DEVICE USING SAME

(71) Applicant: TRIPLE WIN TECHNOLOGY(SHENZHEN) CO.LTD., Shenzhen (CN)

(72) Inventors: YU-SHUAI LI, Shenzhen (CN); SHIN-WEN CHEN, Tu-Cheng (TW); LONG-FEI ZHANG, Shenzhen (CN); KUN LI, Shenzhen (CN)

(21) Appl. No.: 16/693,694

(22) Filed: Nov. 25, 2019

(30) Foreign Application Priority Data
Aug. 30, 2019 (CN) 201910817626.4

(51) Int. Cl. H04N 5/225; G02B 7/02

(52) U.S. Cl. CPC H04N 5/2254; H04N 5/2253; G02B 7/025; H04N 5/2252

(57) ABSTRACT

A lens module able to disperse accumulated water vapor includes a circuit board, a carrier, a glass cover, an image sensor, and a reinforcement layer. The carrier on the circuit board defines an opening on a side away from the circuit board and carries the glass cover. The circuit board, the glass cover, and the carrier enclose a receiving chamber containing the image sensor. A projection of the opening on the circuit board partially overlaps a projection of the image sensor on the circuit board. The reinforcement layer on an inner surface of the carrier adjacent to the receiving chamber absorbs water vapor and any stray light reflected from the image sensor to improve image quality. An electronic device including the lens module is also disclosed.

### FIELD

The subject matter relates to imaging.

### BACKGROUND

Portable electronic devices, such as cell phones, tablet computers, and multimedia players, usually include lens modules. The lens modules are sealed to prevent moisture or impurities from entering. However, water vapor generated in the lens modules may not be able to escape, water mist or droplets may form on inner surfaces of glass covers of the lens modules. Thus, image quality of the lens modules is reduced. In addition, light in the sealed lens modules may be diffusely reflected or scattered, which further lowers the image quality of the lens modules.

### BRIEF DESCRIPTION OF THE DRAWINGS

Implementations of the present technology will now be described, by way of embodiments, with reference to the attached figures.

FIG. 1 is an isometric view of an embodiment of a lens module.

FIG. 2 is an exploded, isometric view of the lens module of FIG. 1.

FIG. 3 is an isometric view of a carrier of the lens module of FIG. 1.

FIG. 4 is a cross-sectional view taken along line IV-IV of FIG. 1.

FIG. 5 is a schematic view of paths of water vapor dispersal in a receiving chamber of the lens module of FIG. 1.

FIG. 6 is a schematic view of paths of light transmission in a receiving chamber of the lens module of FIG. 1.

FIG. 7 is a perspective view of an electronic device including the lens module of FIG. 1.

### DETAILED DESCRIPTION

It will be appreciated that for simplicity and clarity of illustration, where appropriate, reference numerals have been repeated among the different figures to indicate corresponding or analogous components. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

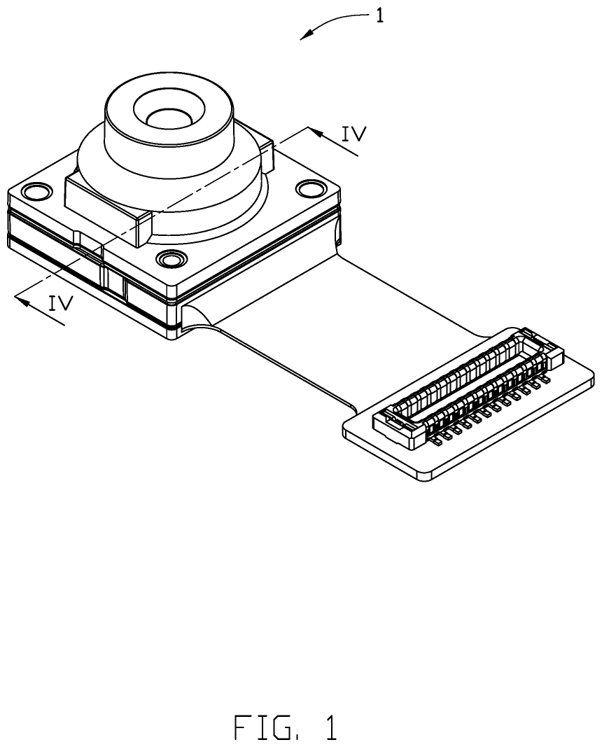

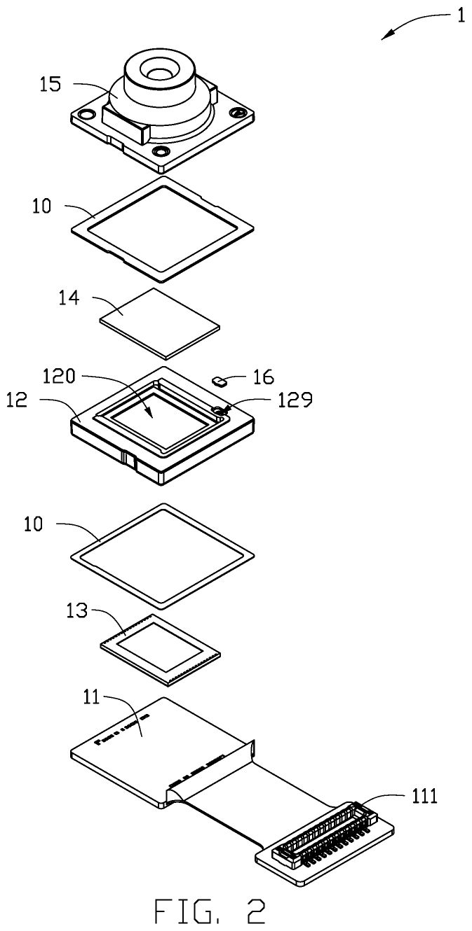

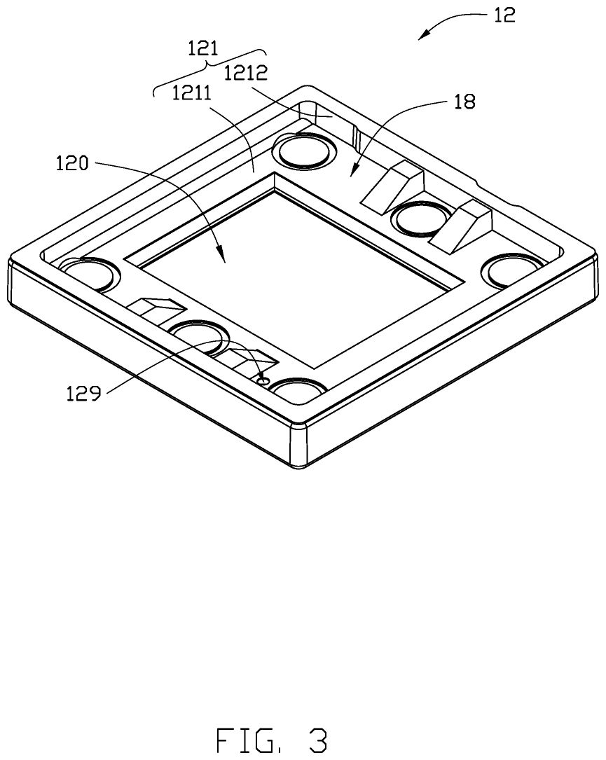

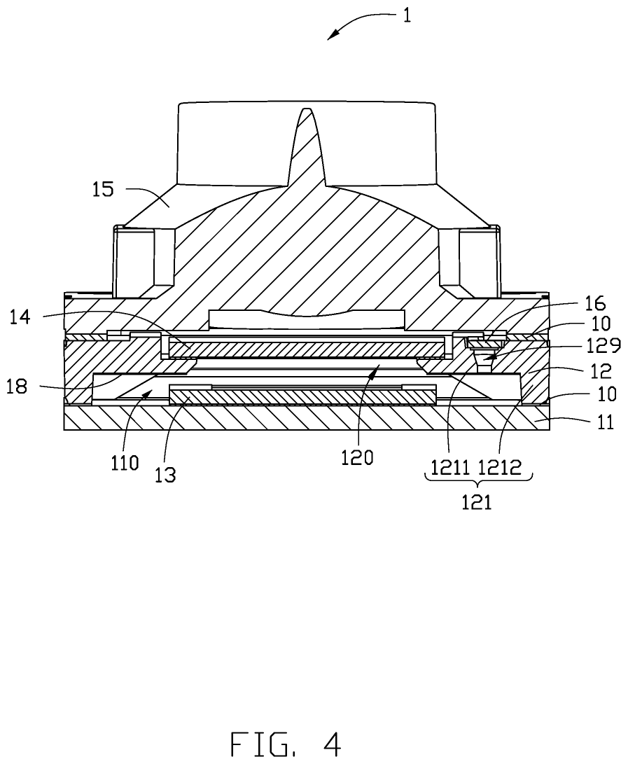

FIGS. 1 to 4 illustrate an embodiment of a lens module (lens module 1). The lens module 1 includes a circuit board 11, an image sensor 13, an adhesive layer 10, a carrier 12, a sealing element 16, a glass cover 14, and a lens 15.

The carrier 12 is arranged on a surface of the circuit board 11. The carrier 12 defines an opening 120 on a side away from the circuit board 11. The glass cover 14 is arranged on a side of the opening 120 away from the circuit board 11 and covers the opening 120. The circuit board 11, the glass cover 14, and the carrier 12 enclose a receiving chamber 110. The image sensor 13 is received in the receiving chamber 110, and is arranged on the surface of the circuit board 11. A projection of the opening 120 on the circuit board 11 at least partially overlaps a projection of the image sensor 13 on the circuit board 11. The carrier 12 supports the lens 15. The lens 15 is arranged on the side of the carrier 12 away from the circuit board 11, and at least a part of the lens 15 corresponds in position to the opening 120. An external light enters into the lens 15 from a side away from the glass cover 14, and successively passes through the lens 15, the glass cover 14, and the opening 120 to reach the image sensor 13. In other words, the external light enters into an inner chamber of the lens 15, passes through the inner chamber of the lens 15 to reach the glass cover 14, passes through the glass cover 14 and the opening 120 to enter into the receiving chamber 110, and reaches the image sensor 13 in the receiving chamber 110.

The circuit board 11 can be a flexible board, a rigid board, or a rigid-flexible board. One end of the circuit board 11 carries a connection port 111, which is configured to electrically connect to an external circuit (not shown) and implement signal transmission between the circuit board 11 and the external circuit. The image sensor 13 is in electrical communication with the circuit board 11. Electrical signals of the image sensor 13 can be transmitted to the external circuit through the circuit board 11, and the image sensor 13 can receive the electrical signals through the circuit board 11.

The carrier 12 is fixed on the circuit board 11 by the adhesive layer 10 to form the receiving chamber 110. The receiving chamber 110 is sealed to prevent entry of impurities, thus the image sensor 13 received in the receiving chamber 110 is not affected by impurities.

The carrier 12 includes an inner surface 121 adjacent to the receiving chamber 110. The inner surface 121 includes a first surface 1211 facing the circuit board 11 and a first side face 1212 adjacent to and surrounding the first surface 1211. The opening 120 passes through the first surface 1211. The first side face 1212 is arranged between the first surface 1211 and the circuit board 11. The adhesive layer 10 is arranged between the first side face 1212 and the circuit board 11. The lens module 1 further includes a reinforcement layer 18, which can be arranged on the inner surface 121. The reinforcement layer 18 can be arranged on the inner surface 121 by coating, adhering, or pressing in place. In an alternative embodiment, the reinforcement layer 18 can be arranged on at least one of the first surface 1211 and the first side face 1212.

The reinforcement layer 18 absorbs both water vapor and light. In one embodiment, the reinforcement layer 18 is a composite film containing silica and titanium dioxide.

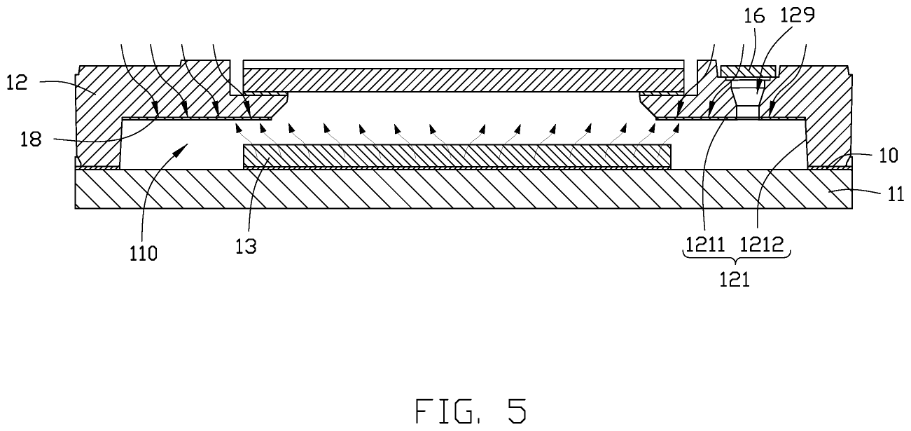

When the lens module 1 is in a high temperature and/or a high humidity environment, water is more likely to be absorbed by elements of the lens module 1, such as the carrier 12. FIG. 5 illustrates a dispersal of water vapor by a build-up of working heat in the receiving chamber 110. The reinforcement layer 18 on the inner surface 121 of the carrier 12 absorbs water vapor in the receiving chamber 110 and water vapor penetrating into the receiving chamber 110 from the carrier 12, thus the receiving chamber 110 is kept dry. Formation of water mist or small droplets on an internal surface of the glass cover 14 is avoided, and an image quality of the lens module 1 is improved.

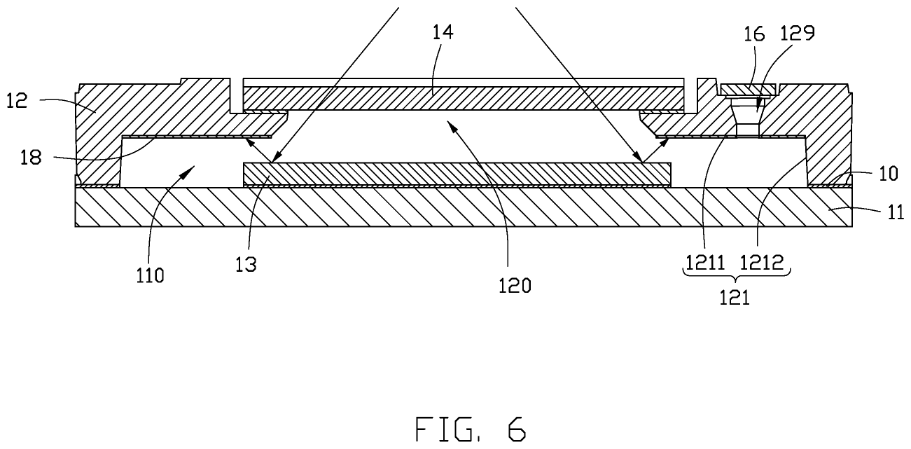

FIG. 6 illustrates that a part of light reaching the image sensor 13 is reflected to the inner surface 121 of the carrier 12 and is absorbed by the reinforcement layer 18 on the inner surface 121. The part of light reaching the inner surface 121 is not reflected back to the image sensor 13, the image quality of the lens module is further improved.

The carrier 12 defines a gas escape hole 129, through which gas can escape when the lens module 1 is in assembly. The sealing element 16 is movably arranged in the gas escape hole 129. When the lens module is in use, the sealing element 16 seals the gas escape hole 129, thus the receiving chamber 110 is sealed.

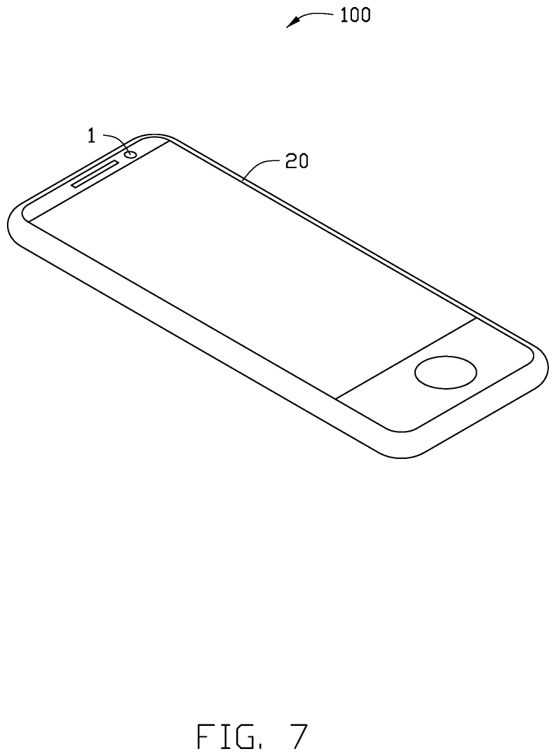

FIG. 7 illustrates an embodiment of an electronic device 100. The electronic device 100 includes a base body 20 and the lens module 1 arranged in the base body 20. The electronic device 100 can be any electronic device having imaging capturing functions, such as mobile phones, wearable devices, computer devices, vehicles, or monitoring devices. In an alternative embodiment, the electronic device 100 is a mobile phone.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present exemplary embodiments, to the full extent indicated by the plain meaning of the terms in which the appended claims are expressed.

What is claimed is:

1. A lens module comprising:
a circuit board;
a carrier arranged on a surface of the circuit board and defining an opening on a side away from the circuit board;
a glass cover arranged on a side of the opening away from the circuit board, the circuit board, the glass cover, and the carrier enclosing a receiving chamber, the carrier defining an inner surface adjacent to the receiving chamber;
an image sensor arranged on a surface of the circuit board and received in the receiving chamber, a projection of the opening on the circuit board at least partially overlapping a projection of the image sensor on the circuit board; and
a reinforcement layer arranged on the inner surface and configured to absorb water vapor and light reflected from the image sensor.

2. The lens module of claim 1, wherein the reinforcement layer comprises silica and titanium dioxide.

3. The lens module of claim 1, wherein the inner surface comprises a first surface facing the circuit board and a first side face adjacent to and surrounding the first surface, the opening penetrates the first surface, the first side face is arranged between the first surface and the circuit board.

4. The lens module of claim 3, wherein the reinforcement layer is arranged on the first surface.

5. The lens module of claim 3 wherein the reinforcement layer is arranged on the first surface and the first side face.

6. The lens module of claim 4, wherein the carrier defines a gas escape hole penetrating through the carrier and the first surface, the carrier further comprises a sealing element which is movably arranged in the gas escape hole.

7. The carrier of claim 5 wherein the carrier defines a gas escape hole through the carrier and the first surface, the carrier further comprises a sealing element which is movably arranged in the gas escape hole.

8. The lens module of claim 1, further comprising a lens arranged on a side of the carrier away from the circuit board, at least a part of the lens corresponding in position to the opening.

9. The lens module of claim 8, wherein a path of light entering the lens module from an exterior comprises: entering into the lens from a side away from the glass cover, and successively passing through the lens, the glass cover, and the opening, and reaching the image sensor.

10. An electronic device comprising:
a base body; and
a lens module arranged in the base body, the lens module comprising:
a circuit board,
a carrier arranged on a surface of the circuit board and defining an opening on a side away from the circuit board,
a glass cover arranged on a side of the opening away from the circuit board, the circuit board, the glass cover, and the carrier enclosing a receiving chamber, the carrier defining an inner surface adjacent to the receiving chamber,
an image sensor arranged on a surface of the circuit board and received in the receiving chamber, a projection of the opening on the circuit board at least partially overlapping a projection of the image sensor on the circuit board, and
a reinforcement layer arranged on the inner surface and configured to absorb water vapor and light.

11. The electronic device of claim 10, wherein the reinforcement layer comprises silica and titanium dioxide.

12. The electronic device of claim 10, wherein the inner surface comprises a first surface facing the circuit board and a first side face adjacent to and surrounding the first surface, the opening penetrates the first surface, the first side face is arranged between the first surface and the circuit board.

13. The electronic device of claim 12, wherein the reinforcement layer is arranged on the first surface.

14. The electronic device of claim 12, wherein the reinforcement layer is arranged on the first surface and the first side face.

15. The electronic device of claim 13, wherein the carrier defines a gas escape hole penetrating through the carrier and the first surface, the carrier further comprises a sealing element which is movably arranged in the gas escape hole.

16. The electronic device of claim 14, wherein the carrier defines a gas escape hole through the carrier and the first surface, the carrier further comprises a sealing element which is movably arranged in the gas escape hole.

17. The electronic device of claim 10, further comprising a lens arranged on a side of the carrier away from the circuit board, at least a part of the lens corresponding in position to the opening.

18. The electronic device of claim 17, wherein a path of light entering the lens module comprises: entering into the lens module from a side away from the glass cover, and successively passing through the lens, the glass cover, and the opening, and reaching the image sensor.
